(19) United States
(12) Patent Application Publication
(10) Pub. No.: US 2006/0085959 A1
(43) Pub. Date: Apr. 27, 2006

(54) Machine tool structure

(75) Inventor: William Yang, Tainan Hsien (TW)

Correspondence Address: BACON & THOMAS, PLLC, 625 SLATERS LANE, FOURTH FLOOR, ALEXANDRIA, VA, 22314, US

(73) Assignee: MACRO MICRO TECH. INC., Tainan Hsien (TW)

(21) Appl. No.: 11/126,237

(22) Filed: May 11, 2005

(30) Foreign Application Priority Data
Oct. 26, 2004 (TW) 93216951
Oct. 26, 2004 (TW) 93216950

(51) Int. Cl. B23B 39/00

(52) U.S. Cl. 29/26 A

(57) ABSTRACT

The machine tool structure of the invention is : saddle which can slide toward X axle direction set at the machine table; bed which can slide toward Y axle direction set at the saddle; door type machine pole which includes vertical and horizontal poles set at the bed; a machine head which can load cutting main shaft and can only move toward Z axle direction but not Y axle direction at horizontal pole set at the horizontal pole; the center of the lead screw leaning into one side near machine pole of the plane surface which is created by the sliding rail between the machine head and machine pole; this causes the gravity center of the machine head moving toward the machine pole.

### BACKGROUND OF THE INVENTION

1. Field of the Invention

This invention relates to a machine tool structure, specially for the kind of machine head leaning into machine pole, and machine head which is not sliding on horizontal pole for Y axle direction but only sliding for Z axle direction. In addition, horizontal machine head can be installed on machine pole and the structure of the machine tool becomes vertical-and-horizontal double entry functions.

2. Description of the Related Art

There are many kinds of machine tools, e.g. vertical machine tool, horizontal machine tool or planer machine tool, and the invention can be applied on all kinds of machine tools. Take the application on planer machine tool as an example, say as shown on FIG. 1, bed 11 which is set on machine table 1, and sliding rail 12 on which bed 11 can slide toward X axle direction is set between them; door type machine pole 13 is set above bed 11; machine pole 13 includes vertical poles 131 beside bed 11 and horizontal pole 132 above bed 11; a headstock 14 is set on machine pole 13; sliding rail 15 is set up between them to make headstock 14 can move toward Y axle direction. Machine head 17 which can carry cutting main shaft 16 is set on headstock 14, sliding rail 18 is set between them (refer to FIG. 2) and make machine head 17 move upward-and-downward following Z axle direction, driving by lead screw 19. Referring to FIG. 2 and FIG. 3 at the same time, lead screw 19 and sliding rails 18 beside headstock 14 are located at the same plane surface. Since main shaft 16, at FIG. 3 arrow Z showing that when moving upward and downward to proceed cutting processes, the resistance of cutting would create counterforce which creates torque on sliding rail 18 and lead screw 19 located at the same plane surface.

Besides, at Z axle direction, there is a big gap between center of cutting main shaft 16 and sliding rail 15 which is located at machine pole 13, and the cast machine head 17 is very heavy, hence, when machine head 17 is sliding fast on sliding rail 15 at Y axle direction, it will cause very big torque and serious vibration. This will affect the precision of processing seriously.

Furthermore, the plane surface where the gravity center of machine head 17 and sliding rail 18 located will create side-directing force shown as the arrow F on FIG. 3. The side-directing force not only make load and damage which are created by same level of torque on lead screw 19 become more serious and cause the mechanism unstable, but also make machine head 17 be vibrating easily when moves fast. This causes lower cutting precision, knife worn and shorter working life, and exhausts machine energy.

### SUMMARY OF THE INVENTION

The objective of this invention is to provide and improved machine tool structure which includes: a saddle set at the machine table and sliding rail set between them, this make the saddle can move toward X axle direction; a bed set at the saddle and sliding rail set between them, and this make the bed can move toward Y axle direction; a door type machine pole set at the bed, and the machine pole including the vertical poles at the sides of the bed and the horizontal pole above the bed; a machine head which can load cutting main shaft set at the horizontal pole of the machine pole and sliding rail set between them; the machine head set at the certain position of the horizontal pole and only driven by a lead screw to move toward Z axle direction but not move toward Y axle direction at the horizontal pole.

The other feature of the invention: a machine head which can load cutting main shaft set at the machine pole of the machine tool and sliding rail set between them; this cause the machine head be driven by a lead screw to move upward and downward; the center of the lead screw and the sliding rail mentioned above do not locate at the same plane surface and center of the lead screw leaning into one side near the machine pole of the plane surface which is created by the sliding rail; this causes the gravity center of the machine head moving toward the machine pole which is more rigid and stable.

### BRIEF DESCRIPTION OF THE DRAWINGS

Other features and advantages of the present invention will become apparent in the following detailed description of the preferred embodiments, with reference to the accompanying drawings, in which:

FIG. 1 is a simple three-dimensional sketch map of a well-known machine tool structure.

FIG. 2 is a simple partial structure vertical-view sketch map between machine head and machine pole of a well-known machine tool.

FIG. 3 is a simple partial structure lateral-view sketch map between machine head and machine pole of a well-known machine tool.

FIG. 4 is a structure sketch map of the invention preferred embodiments.

FIG. 5 is a simple partial structure vertical-view sketch map between machine head and machine pole of the invention preferred embodiments.

FIG. 6 is a simple partial structure lateral-view sketch map between machine head and machine pole of the invention preferred embodiments.

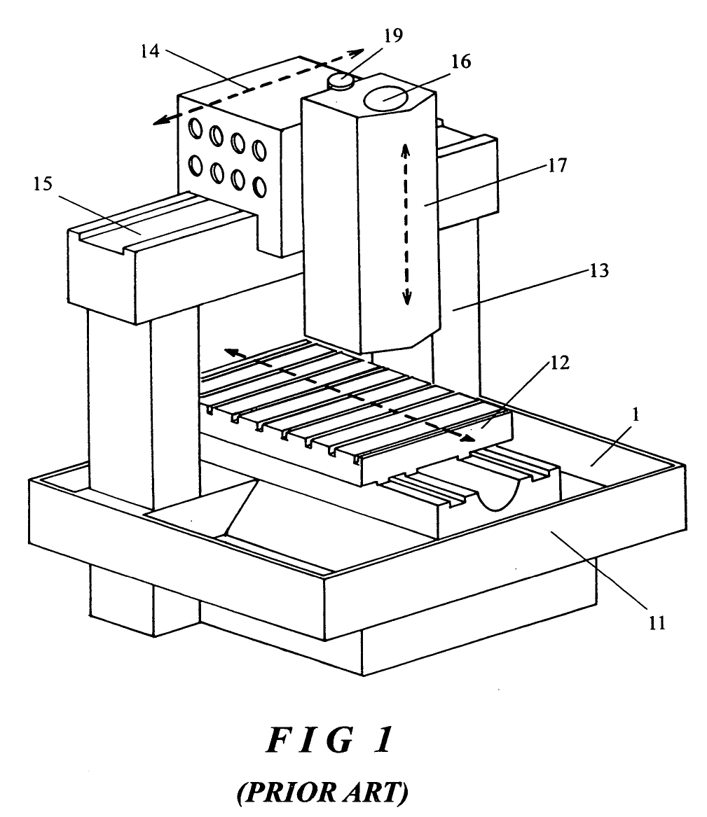

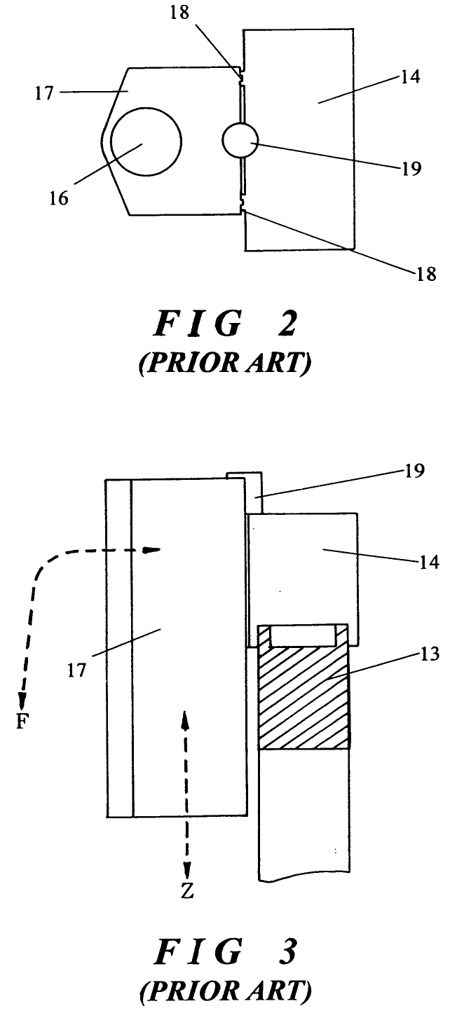

### DETAILED DESCRIPTION OF THE PREFERRED EMBODIMENTS

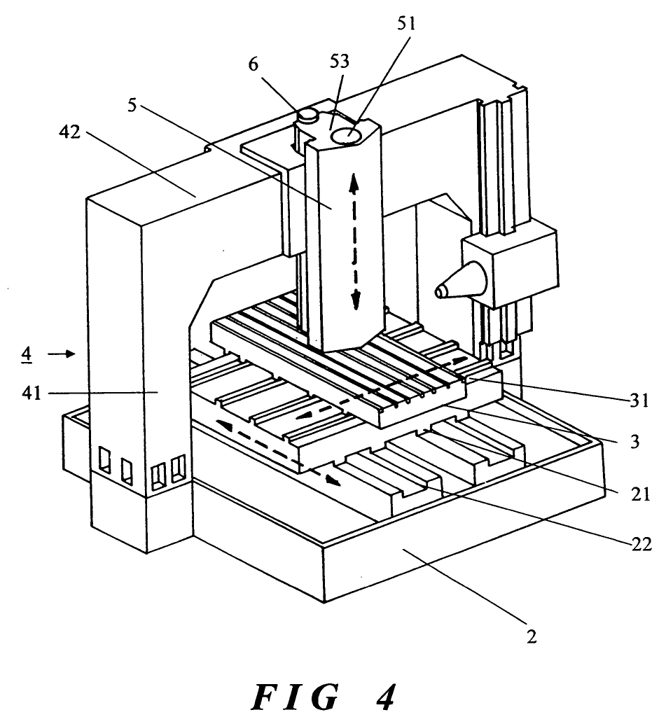

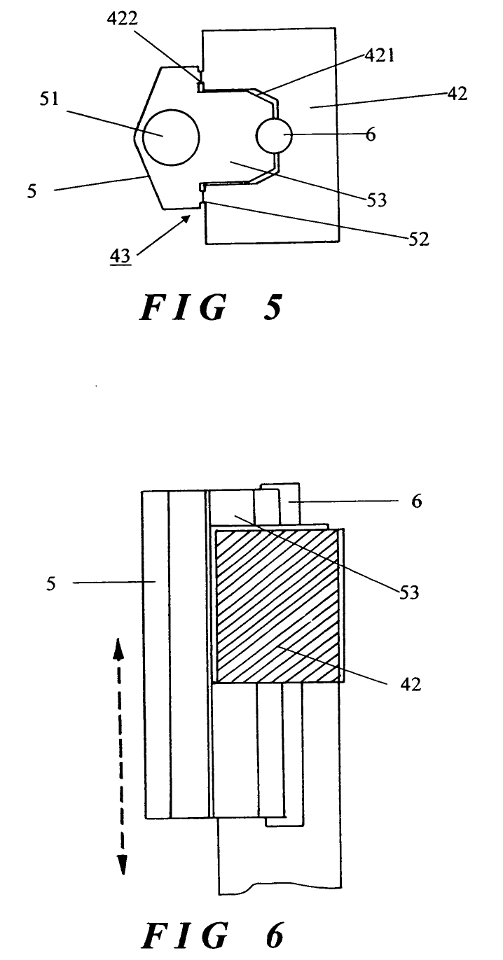

In the detailed description of the preferred embodiments, it should be noted that like elements are indicated by the same reference numerals throughout the disclosure. Referring to FIG. 4, the invention preferred embodiments can be taken as including a vertical type of machine tool set and a horizontal type of machine tool set; in which: Vertical machine tool includes: saddle 21 set at the machine table 2; sliding rail 22 set between them to make saddle 21 can move toward X axle direction; bed set at the saddle 21; sliding rail 31 set between them to make the bed 3 can move toward Y axle direction; door type machine pole 4 set at the bed 3; machine pole 4 including vertical poles 41 located sides of the bed 3 and horizontal pole 42 set above the bed 3, and the whole machine pole was cast as one body; a machine head 5 can load cutting main shaft 51 set at the horizontal pole 42 of the machine pole 4, and sliding rail 43 set between them (refer to FIG. 5); this can make machine head 5 be driven by a lead screw 6 to move toward Z axle upward and downward; in which, the machine head 5 set at the horizontal pole 42 only can move toward Z axle direction but not Y axle direction at horizontal pole 42. By means of bed 3 moving toward Y axle direction, saddle 21 moving toward X axle direction, cutting main shaft 51 moving toward Z axle upward and downward, the three-dimensional, toward X, Y, Z axle direction, processing has been established.

Horizontal machine tool includes: machine head 5 set at the certain position of horizontal pole 42 and can only move toward Z axle direction but not Y axle direction at horizontal pole 42, hence vertical poles 41 located at the machine pole 4 and sides of bed 3 won't be affected by the machine head's possible sliding hit; and then, maintain enough space to install other cutting devices. The enforcing case of the invention is setting a horizontal machine tool including a tool head 7 located at one side of the vertical poles 41 and sliding on sliding rail 44 toward Y axle direction upward and downward (The definition of X, Y, Z axle of the horizontal machine tool is different from that of the vertical machine tool mentioned above.) The machine head 7 loads a cutting main shaft 71 which can carry knife to proceed processing on working piece at bed 3. In the meanwhile, for horizontal machine tool, the definition of bed 3 and saddle 21 movement can be considered as cutting main shaft 71 moving toward Z axle direction and X axle direction.

In the enforcing case of the invention, bed 3 can install a turntable to match with the cutting main shaft 71 at the horizontal tool head 7 or the cutting main shaft 51 at machine head 5 to proceed processing. The wide range and multiple axle direction processing ability can meet the requirement of processing. In addition, in the enforcing case of the invention, since the operation is under the environment of the stable dragon door type machine pole 4 which includes horizontal pole 42 and two vertical poles 41, if only horizontal machine tool is operated, comparing with the horizontal tool head 7 held by single pole of the general horizontal machine tool, the result will be much better.

Referring to FIG. 5, a concave area 421 set at the horizontal pole 42 of machine pole 4 and line rail seat 422 set at sides of the concave area 421. Rail 52 set at both sides of the machine head 5 equipped with cutting main shaft 51 and embedded in line rail seat 422 named above. Line rail seat 422 and rail 52 establishing a sliding rail 43 for moving machine head 5. Body 53 cast piece of machine head 5 extended into concave area 421 of machine pole 4; machine body 53 connected with machine pole 3 via lead screw 6 at the area approaching concave area 421 base and driven by the lead screw. Center of lead screw 6 and sliding rail 43 located at both sides of the concave area 421 are not at the same plane surface. Center of lead screw 6 leaning into the plane surface and slanting to one side of horizontal pole 42 of the machine pole 4, created by sliding rail 43, and maintaining suitable distance. In design, even can make center of cutting main shaft 51 of the machine head 5 located almost at the same plane surface of the sliding rails 43 at both sides.

In the enforcing case of the invention, center of lead screw 6 and sliding rail 43 set at the concave area 421 at horizontal pole 42 of the machine pole 4 do not locate at the same plane surface; slanting to one side of horizontal pole 42 of the machine pole 4 at the plane surface and this make gravity center of machine head 5 cast piece extend toward concave area 421 at horizontal pole of machine pole 4. It shows that gravity center of machine head 5 moving toward higher rigidity and stability of machine pole 4. This causes lead screw 6 making use of the counterforce created when main shaft 51 proceeding cutting processes to drive machine head 5 moving upward or downward, or the lateral force torque created by the weight of machine head 5 make the distance between cutting main shaft 41 and the plane surface be decreased, since lead screw 6 leaning at one side of the vertical plane surface that the rail 43 of cutting main shaft 51 located. As decreasing counterforce mentioned above and torque created by weight of machine head 5, decrease or eliminate the lateral force created possibly by machine head 5 to reach the stable simple upward and downward driving status shown as FIG. 6 arrow G This make cutting precision better than well-known machine tool. In the enforcing case of the invention, if cutting main shaft 51 and sliding rails 43 at both sides locating at the same plane surface, then, the torque created by the counterforce when cutting main shaft 51 proceeding cutting processes would become zero almost.

To sum it up, the design of fix type of machine head, in the enforcing case of the invention, not only cause the machine pole and vertical poles 41 at both sides of bed 3 be not affected by possible hit from the sliding of machine head 5, and maintain enough space for other cutting tool devices, but also make machine head 5 no need to slide toward Y axle direction to avoid torque creating by speeding movement of heavy machine head. The improved method that bed 3 and saddle 21 pile horizontally to get more stable driving status can increase precision of cutting. In addition, gravity center of machine head 5 cast piece leaning to machine pole 4 which has higher rigidity and stability decreases or eliminates torque of lateral force, and this can decrease vibration, energy consumption and abrasion of knife. Hence, the application life of knife, speeding movement ability of machine head 5, stability and precision of cutting processing processes have been increased.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A machine tool structure includes:
saddle set at the machine table; sliding rail set between them to make saddle can move toward X axle direction; bed set at the saddle; sliding rail set between them to make the bed can move toward Y axle direction; door type machine pole set at the bed; machine pole including vertical poles located sides of the bed and horizontal pole set above the bed, and the whole machine pole was cast as one body; a machine head which can load cutting main shaft set at the horizontal pole of the machine pole, and sliding rail set between them; the machine head set at the horizontal pole only can move toward Z axle direction but not Y axle direction at horizontal pole.

2. A machine tool structure as claimed in claim 1, wherein said vertical pole of machine pole is equipped with device that can load knife to proceed processing processes on working piece on the bed.

3. A machine tool structure as claimed in claim 2, wherein said tool equipment is a horizontal machine tool and it is equipped with horizontal tool head that can move upward and downward on sliding rail at the vertical pole; the tool head is loaded with cutting main shaft which can load knife to proceed processing processes on working piece on the bed.

4. A machine tool structure as claimed in claim 1, wherein said the center of the lead screw and the sliding rail between machine head and machine pole do not locate at the same plane surface and center of the lead screw leaning into one side near the machine pole of the plane surface which is created by the sliding rail; this causes the gravity center of the machine head moving toward the machine pole which is more rigid and stable.

5. A machine tool structure includes:
a machine head which can load cutting main shaft set at the machine pole of the machine tool and sliding rail set between them; this cause the machine head be driven by a lead screw to move upward and downward; the center of the lead screw and the sliding rail mentioned above do not locate at the same plane surface and center of the lead screw leaning into one side near the machine pole of the plane surface which is created by the sliding rail; this causes the gravity center of the machine head moving toward the machine pole which is more rigid and stable.

6. A machine tool structure as claimed in claim 5, wherein said center of cutting main shaft of the machine head located at the same plane surface with the sliding rail between machine head and machine pole.

7. A machine tool structure as claimed in claim 5, wherein said a concave area is set at the machine pole and body of the machine head extends toward the concave area mentioned.

8. A machine tool structure as claimed in claim 6, wherein said sliding rails are set at the both sides of the concave area.

9. A machine tool structure as claimed in claim 5, wherein said machine pole includes vertical poles at both sides and horizontal pole which load machine head.

10. A machine tool structure as claimed in claim 9, wherein said a concave area is set at the horizontal pole of machine pole and body of the machine head extends toward the concave area mentioned.

11. A machine tool structure as claimed in claim 5, wherein said the machine head set at the horizontal pole only can move toward Z axle direction but not Y axle direction at horizontal pole.
